(19) United States
(12) Patent Application Publication
(10) Pub. No.: US 2019/0034252 A1
(43) Pub. Date: Jan. 31, 2019

(54) PROCESSOR ERROR EVENT HANDLER

(71) Applicant: HEWLETT PACKARD ENTERPRISE DEVELOPMENT LP, HOUSTON, TX (US)

(72) Inventors: Mark S Fletcher, Houston, TX (US); Robert C Elliott, Houston, TX (US)

(21) Appl. No.: 15/662,967

(22) Filed: Jul. 28, 2017

(51) Int. Cl. G06F 11/07

(52) U.S. Cl. CPC G06F 11/073; G06F 11/0745; G06F 11/0706; G06F 11/1048; G06F 11/0712; G06F 11/079; G06F 11/0793

(57) ABSTRACT

A system includes a processor that includes a memory checker to access data from a memory and to set a processor corruption error (PCE) if a memory error is detected with the accessed data. The processor includes a status register to report the PCE and to identify a failed address from which the memory error was detected. An event handler receives the PCE and the failed address from the status register of the processor. The event handler blocks notification of the PCE to an operating system based on the failed address and notifies the operating system of the failed address to mitigate failure of the operating system.

### BACKGROUND

A microprocessor is a computer processor that incorporates the functions of a computer's central processing unit (CPU) on to a single integrated circuit (IC). In some older classes of microprocessors, different printed circuit board (PCB) sockets were employed to mount the microprocessors to the PCB depending on the class. In newer architectures, multiple processor classes can be accommodated by the same socket type. Beyond package differences between microprocessors, the microprocessor is a multipurpose digital-integrated circuit that accepts binary data as input, processes it according to instructions stored in its memory, and provides processing results as output. Other results than encountered from normal processing of instructions can also be provided. For example, memory test functions executed by the microprocessor (or associated circuits) can also be executed where error bits can be set if memory errors are detected in accordance with a given memory test.

### BRIEF DESCRIPTION OF THE DRAWINGS

FIG. 1 illustrates an example system to process memory errors to mitigate shutdown of an operating system.

FIG. 2 illustrates an example system to process memory errors and notify an operating system to mitigate shutdown of the operating system.

FIG. 3 illustrates an example method to process memory errors to mitigate shutdown of an operating system.

### DETAILED DESCRIPTION

A system is provided that determines a failed address from a memory where a memory error has occurred and notifies an operating system to avoid the failed address when accessing the memory. Rather than shutting down the operating system by generating a processor corruption error (PCE) exception as in previous systems, the systems and method described herein block notification of the PCE to mitigate operating system shutdown. Notice of the failed address is provided to the operating system to allow it to avoid the failed address during future access to the memory.

The system includes a processor that includes a memory checker to access data from a memory and to set a processor corruption error (PCE) if a memory error was detected with the accessed data. The memory checker can be executed via an internal memory controller (IMC) of the processor which continually scans memory to detect errors utilizing error checking and correction codes (ECC) to detect errors from a given memory location. The processor includes a status register to report the PCE and to identify a failed address from which the memory error was detected. An event handler receives the PCE and the failed address from the status register of the processor.

The event handler blocks notification of the PCE to the operating system based on the failed address and notifies the operating system of the failed address to mitigate failure of the operating system. A table can be employed to list the memory address of the memory error. The event handler issues a notification to the operating system (e.g., via an interrupt) and supplies the failed memory address via the table indicating where the memory error occurred and from which the PCE was generated. Using the list, the operating system can avoid the memory location from where the memory error occurred while continuing operations in many cases and without shutting down like previous systems when such errors occurred.

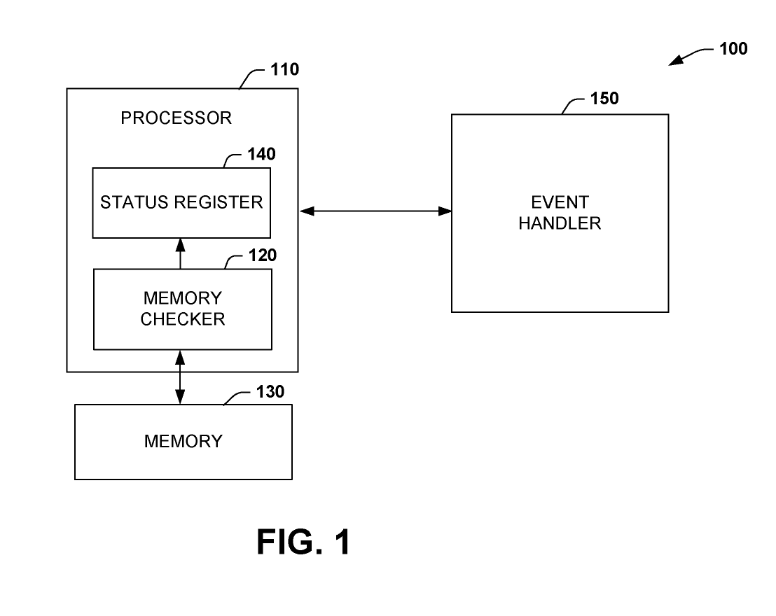

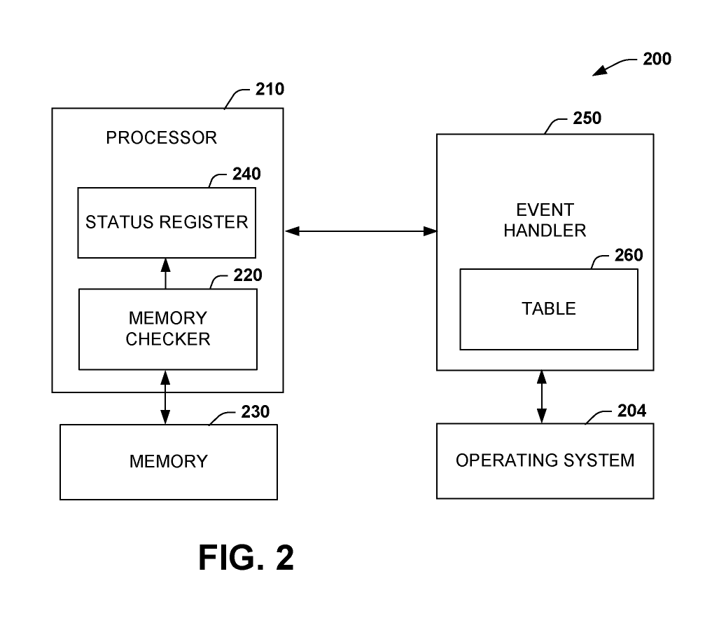

FIG. 1 illustrates an example system 100 to process memory errors to mitigate shutdown of an operating system. The 100 system includes a processor 110 that includes a memory checker to access data from memory 130 and to set a processor corruption error (PCE) if a memory error was detected with the accessed data. A specific example of a PCE is a processor context corrupt (PCC) bit issued by an Intel-based EP-class processor. The PCE indicates (when set) that the state of the processor may have been corrupted by the error condition detected and that reliable restarting of the processor may not be possible. When clear, this flag indicates that the error did not affect the processor's state. The processor 110 includes a status register 140 to report the (PCE) and to identify a failed address from which the PCE was detected. An event handler 150 receives the PCE and the failed address from the status register 140 of the processor 110. The event handler 150 blocks notification of the PCE to an operating system (not shown, see e.g., FIG. 2) based on the failed address and notifies the operating system of the failed address to mitigate failure of the operating system.

With respect to previous systems that would cause operating systems to fail whenever a PCE was detected (e.g., event handlers operating with Intel-based EP-class processors), the event handler when observing the PCE set to binary 1 would pass the PCE to the operating system via a machine check exception (MCE) that would cause the operating system to fail. The MCE is an error detected by a system's processor where there are two types of MCE errors—a notice or warning error, and a fatal exception. The warning can be logged by a “Machine Check Event logged” notice in system logs, and can be later viewed via some Linux utilities, for example. A fatal MCE will cause the machine to stop responding and the details of the MCE can be printed out to the system's console. In contrast and with respect to the system 100 if the PCE is detected, the event handler 150 interrogates the status register 140 to determine the failed address from which the memory error occurred. The event handler 150 then resets the PCE in the processor 110 and does not generate an MCE to the operating system as with previous systems which allows the system 100 to continue to operate when a given memory error is determined by avoiding the failed address in future memory access operations.

The event handler 150 can reset the PCE by writing data to the processor 110 and issuing a notification to the operating system that the memory error has occurred. The event handler can issue the notification as an interrupt to the operating system and supply the failed address via a table (see e.g., FIG. 2) indicating a memory location from which the memory error was detected. In one example, the memory checker 120 can be an integrated memory controller (IMC) (or controllers) in the processor 110 to generate the PCE if the error is detected with the accessed data. The IMC detects the error by comparing a given memory location to error checking and correction (ECC) data saved for the given memory location. The memory 130 can be persistent data memory that is managed via a memory driver under control of the operating system. The memory driver avoids the failed address after notification from the event handler 150. In some examples, the event handler 150 notifies the operating system via a machine check exception (MCE) indicating the PCE has occurred depending on the address location of the failed address (e.g., if a critical address was identified to cause the event handler to shut down the operating system).

FIG. 2 illustrates an example system 200 to process memory errors and notify an operating system 204 to mitigate shutdown of the operating system. The system 200 includes a processor 210 that includes a memory checker 220 to access data from a memory 230 (e.g., persistent memory) and to set a processor corruption error (PCE) if an error is detected with the accessed data. The processor 210 includes a status register 240 to report the (PCE) and to identify a failed address from which the memory error was detected. An event handler 250 receives the PCE and the failed address from the status register 240 of the processor 210. The event handler 250 blocks notification of the PCE to the operating system 204 based on the failed address. A table 260 lists the failed address from which the memory error was detected. The event handler 250 issues a notification (e.g., via an interrupt) to the operating system 204 and supplies the failed address via the table 260 to allow the operating system to avoid the failed address to access the memory.

The following describes examples of processor and event handler execution functionality that relate to the systems described above with respect to FIGS. 1 and 2. On some existing systems operating with lower-end central processing units (CPUs) (e.g., Intel EP-class CPUs), the system fails if the CPU encounters an uncorrectable error (UCE) while reading memory. This includes when an internal memory controller (IMC) engine detects that a UCE has occurred. The UCE is due to the CPU microcode setting a machine check status register with a PCE value of binary 1. In one specific example of a PCE error setting for an EP-class processor, a processor context corrupt (PCC) bit can be set to 1 when an error is detected. The PCC indicates (when set) that the state of the processor may have been corrupted by the error condition detected and that reliable restarting of the processor may not be possible. When clear, this PCC flag indicates that the error did not affect the processor's state. Thus, software restarting may be possible. In certain existing event handler implementations, however, machine-check exceptions (MCE) along with notice of the PCE were automatically sent to the operating system that caused the operating system to shut down.

The system 200 however can block MCEs due to IMC activity by consuming the error (e.g., by not passing the MCE along with status of the PCE to the operating system). If an application attempts to read such an address where the error was detected, it is possible the application may fail yet the operating system can still continue to operate (e.g., by rebooting the application). However, application failures may not occur if the failed address is not currently encountered by a given application before notice of the failed address has been received by the operating system via the table 260. The event handler 250 can mitigate application failure in addition to overall operating system failure by utilizing the table 260 to quarantine failed addresses from being accessed in the future by respective applications and/or the operating system.

By way of example, the event handler 250 can clear the PCE bit before reporting the MCE to the operating system 204. For errors detected by the IMC engine, the event handler 250 can add the failed address to the table 260 (e.g., Address Range Scrub (ARS) list) and signal via an interrupt notification to notify the operating system 204 that the table has been updated. In this manner, the operating system 204 and its associated memory drivers can be alerted to return errors for read and write functions that access the affected failed sectors of memory and can thus arrange for load/store accesses for such memory mapped-regions via the listed addresses in the table 260 to fail. If the updated table 260 is read by the operating system before a failed address is encountered, then the MCE and resulting system failures of previous systems can be avoided.

If the table notification does not happen in time (e.g., application encounters failed address before operating system is notified), then blocking notification of the PCE as described herein can allow the operating system 204 to continue. By implementing the PCE blocking capabilities as described herein, advanced operating system capabilities can be provided on lower end CPUs such as EP-class systems. For instance, Linux operating systems have a memcpy_mcsafe( ) function that currently operates with advanced CPUs (e.g., EX-class CPUs) but not lower end CPUs such as EP-class. Such functionality can now be implemented on EP-class systems, for example, by blocking notification of the PCE to the operating system 204 and notifying the operating system of the failed address as described herein.

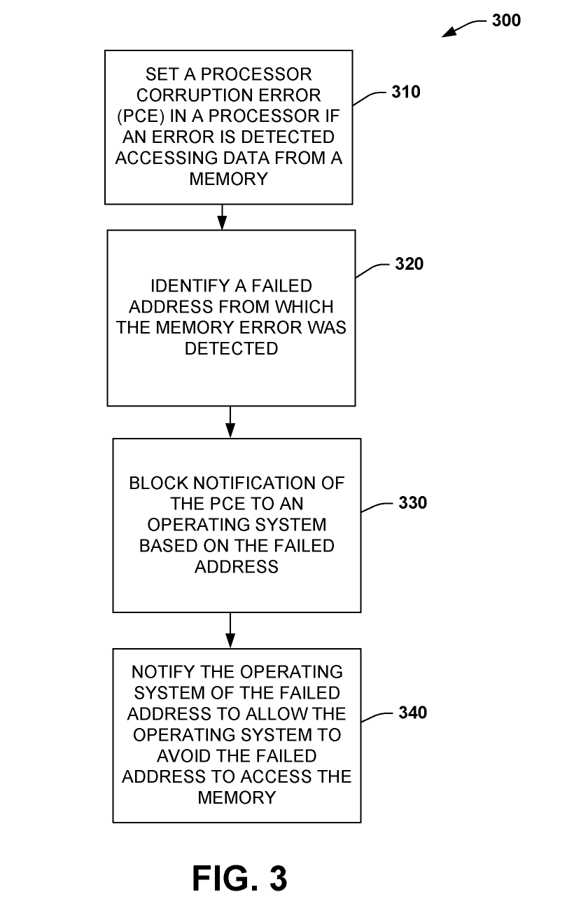

In view of the foregoing structural and functional features described above, an example method will be better appreciated with reference to FIG. 3. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured as machine-readable instructions stored in memory and executable in an integrated circuit or a processor, for example.

FIG. 3 illustrates an example method 300 to process memory errors to mitigate shutdown of an operating system. At 310, the method 300 includes setting a processor corruption error (PCE) in a processor if an error is detected accessing data from a memory (e.g., via memory checker 120 or 220). At 320, the method 300 includes identifying a failed address from which the memory error was detected (e.g., via event handler 150 or 250 and status register 140 or 240). At 330, the method 300 includes blocking notification of the PCE to an operating system based on the failed address (e.g., via event handler 150 or 250). At 340, the method 340 includes notifying the operating system of the failed address to allow the operating system to avoid the failed address to access the memory (e.g., via event handler 150 or 250).

Although not shown, in some examples, the method 300 can also include resetting the PCE by writing data to the processor. The method can include issuing the notification as an interrupt to the operating system and supplying the failed address via a table indicating a memory location from which the memory error was detected. The method can include managing the memory as persistent data memory via a memory driver under control of the operating system where the memory driver avoids the address location of the failed address after the notification. The method includes detecting the error by comparing a given memory location to error checking and correction (ECC) data saved for the given memory location. The method can also include notifying the operating system via a machine check exception (MCE) indicating the PCE has occurred depending on the address location of the failed address.

What have been described above are examples. One of ordinary skill in the art will recognize that many further combinations and permutations are possible. Accordingly, this disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system, comprising:
a processor, comprising:
a memory checker to access data from a memory and to set a processor corruption error (PCE) if a memory error is detected with the accessed data; and
a status register to report the PCE and to identify a failed address from which the memory error was detected; and
an event handler that receives the PCE and the failed address from the status register of the processor, the event handler blocks notification of the PCE to an operating system based on the failed address and notifies the operating system of the failed address to mitigate failure of the operating system.

2. The system of claim 1, wherein the event handler resets the PCE by writing data to the processor and issues a notification to the operating system that the memory error has occurred.

3. The system of claim 2, wherein the event handler issues the notification as an interrupt to the operating system and supplies the failed address via a table indicating a memory location from which the memory error was detected.

4. The system of claim 1, wherein the memory checker is an integrated memory controller (IMC) in the processor to generate the PCE if the error is detected with the accessed data.

5. The system of claim 4, wherein the IMC detects the error by comparing a given memory location to error checking and correction (ECC) data saved for the given memory location.

6. The system of claim 1, wherein the memory is persistent data memory that is managed via a memory driver under control of the operating system, the memory driver avoids the failed address after notification from the event handler.

7. The system of claim 1, wherein the event handler notifies the operating system via a machine check exception (MCE) indicating the PCE has occurred depending on an address location of the failed address.

8. A method, comprising:
setting a processor corruption error (PCE) in a processor if a memory error is detected accessing data from a memory;
identifying a failed address from which the memory error was detected;
blocking notification of the PCE to an operating system based on the failed address; and
notifying the operating system of the failed address to allow the operating system to avoid the failed address to access the memory.

9. The method of claim 8, further comprising resetting the PCE by writing data to the processor.

10. The method of claim 8, further comprising:
issuing the notification of the failed address as an interrupt to the operating system; and
supplying the failed address via a table indicating a memory location from which the memory error was detected.

11. The method of claim 10, further comprising managing the memory as persistent data memory via a memory driver under control of the operating system, the memory driver avoiding the failed address after the notification.

12. The method of claim 8, further comprising detecting the error by comparing a given memory location to error checking and correction (ECC) data saved for the given memory location.

13. The method of claim 1, further comprising notifying the operating system via a machine check exception (MCE) indicating the PCE has occurred depending on an address location of the failed address.

14. A system, comprising:
a processor, comprising:
a memory checker to access data from a memory and to set a processor corruption error (PCE) if a memory error is detected with the accessed data; and
a status register to report the PCE and to identify a failed address from which the memory error was detected;
an event handler that receives the PCE and the failed address from the status register of the processor, the event handler blocks notification of the PCE to an operating system based on the failed address; and
a table to list the failed address from which the memory error was detected, wherein the event handler issues a notification to the operating system and supplies the failed address via the table to allow the operating system to avoid the failed address to access the memory.

15. The system of claim 14, wherein the event handler issues the notification as an interrupt to the operating system and supplies the failed address via the table indicating the failed address from which the memory error was detected.
